(19) United States
(12) Patent Application Publication
(10) Pub. No.: US 2016/0297461 A1
(43) Pub. Date: Oct. 13, 2016

(54) Shopping Cart Bag Holder and Carrier for Cloth, Paper and Plastic Bags, with Handlebar Cover, Assorted Storage Pockets, and Carrying Strap

(71) Applicant: Karla H. Barr-Perea, Huntington Beach, CA (US)

(72) Inventor: Karla H. Barr-Perea, Huntington Beach, CA (US)

(21) Appl. No.: 15/094,941

(22) Filed: Apr. 8, 2016

Related U.S. Application Data
(60) Provisional application No. 62/178,453, filed on Apr. 10, 2015.

(51) Int. Cl. B62B 3/14; A45C 13/02; A45C 1/02; A45C 13/30; A45C 13/10

(52) U.S. Cl. CPC B62B 3/1464; A45C 13/30; A45C 13/10; A45C 13/103; A45C 1/02; A45C 13/02; A45C 2013/1015

(57) ABSTRACT

This bag holder, carrier and organizer facilitates the growing trend of “reduce by reusing” and “bring your own bags” from home. It stores and carries paper, plastic and cloth bags in a compact and organized way. It attaches to any shopping cart handlebar, covering the handlebar completely, and reducing the transfer of germs between shoppers. When put on the handlebar, all the bags become accessible to the shopper. This bag carrier includes a plastic bag dispenser with elasticized openings that help organize plastic bags by size and function, a large open pocket that accommodates folded paper and cloth bags, and a hidden zippered pocket for personal items. The security strap secures the bag carrier onto the cart, and also closes the bag carrier into its closed, carrying position. The carrying strap is used to transport the bag carrier or to hang the bag carrier on a car headrest or other place in the home. Using a set of bags over and over again reduces bag clutter in the home and cuts down on the overall use of “single-use” bags.

### CROSS-REFERENCE TO RELATED APPLICATIONS

This application claims the benefit of PPA Application No. 62/178,453, filed Apr. 10, 2015 by the present inventor, which is incorporated by reference.

### STATEMENT REGARDING FEDERALLY SPONSORED RESEARCH OR DEVELOPMENT

Not applicable

### REFERENCE TO A SEQUENCE LISTING, A TABLE, OR A COMPUTER PROGRAM, LISTING COMPACT DISC APPENDIX

Not applicable

### BACKGROUND OF THE INVENTION

When doing any kind of shopping, many shoppers push a cart with their hands on the handlebar, and quite often shop with a small child or a purse in the shopping cart seat. During checkout, purchased items are usually placed in cloth, plastic or paper bags. This very common shopping process has created several problematic issues: the shopper ends up taking home new paper or plastic bags after each shopping trip, that then build up in the home and have to be dealt with in some way, by either storing, reusing, taking to the recycling center or discarding. Many plastic and paper bags end up in landfills, as generally people do not like too many of them accumulating in their homes. Recycling is a problem because it is an expensive process and not yet cost effective, especially for plastic bags. This single-use bag overload has created an ever-growing environmental problem, especially with plastic bags. Plastic bags end up in our waterways, on our beaches and in our landfills, and contribute to the deaths of many of our animal life through choking and contamination. The primary purpose of this invention is to address this issue of single-use bag overload, by facilitating a shopper's repeated use of a “set of bags” that a shopper brings from home. This could significantly reduce the number of new paper and plastic bags a shopper uses. The secondary issues that this invention attempts to address are as follows:
1. The shopping cart handlebar may be unclean or covered with cold/flu germs from previous shoppers, making it possible to transmit these germs to the next shopper or shopper's child.
2. People have to anticipate how many cloth bags they should take to the grocery store, and may make some unplanned purchases and run out of bags, having to supplement with additional paper/plastic bags.
3. Purses can easily be stolen out of shopping carts if shoppers are distracted while looking at items.
4. Paper and plastic bags accumulate in the home, need a place to be stored, and have to be dealt with.

This invention attempts to address all these issues, with the main focus on reducing paper and plastic bag consumption by facilitating the repeated use of single-use bags.

Classification
Class: 224—Package and Article Carriers
Subclass—314, 400, 409, 411, 412, 413, 420, 484, 605, 659, 925, 926, 935

Search:

1. U.S. Pat. No. 7,958,920

Olsson, Tiffany

Filed—Jul. 23, 2007

A reusable shopping bag ensemble

2. U.S. Pat. No. 80,521,158

Tyrrell, Bruce

Filed: Sep. 5, 2008

Article carrying apparatus for safely carrying loads that are longer than the length of the shopping cart.

3. U.S. Pat. No. 5,297,872

Caligiuri

A reusable shopping bag with attached carrying pouch.

4. Condon, Donna application Ser. No. 14/507,512

Reusable Shopping Bag Storage and Dispensing System

5. Shweta, Soni and Verma Gautam application Ser. No. 12/122,502

Shopping Bag Carrier

6. Linda Diccianni application Ser. No. 12/350,999

Shopping Cart Organizer

### SUMMARY

This embodiment is a bag holder and carrier that attaches to any shopping cart handlebar, converting from its closed position as a shoulder bag packed with paper, plastic and cloth bags, to its open position as a shopping cart handlebar cover and bag organizer, by opening up and attaching to the handlebar, covering the handlebar completely. When attached to the handlebar, all pockets are visible and accessible, and keep different types of bags organized and at a shopper's fingertips while shopping. There is also a hidden, zippered pocket to store personal items, such as wallet and phone.

This bag carrier makes it easy for shoppers to bring their own bags from home, to use these bags while shopping, and additionally, it gives a shopper a place to store their set of bags in the car or in the home. Because a shopper is using the same set of bags again and again until they need to be replaced, the bag carrier could help to significantly reduce the number of new, single-use bags a shopper uses, good for the environment and good for the shopper, as it also reduces bag clutter in the home.

This bag holder and carrier covers the handlebar completely when attached to the shopping cart, and provides a protective germ barrier, minimizing a shopper's contact with the handlebar and providing a clean grabbing surface. This bag holder and carrier has a security strap that can close around the handlebar, as well as a purse handle and keeps both the bag carrier and the purse from being snatched from the cart. It has the capacity to hold numerous bags at once, thus eliminating the possibility of running out of bags while grocery shopping. It folds up and closes into an easy-to-carry-and-store shoulder bag with a carrying strap or handle.

### BRIEF DESCRIPTION OF THE DRAWINGS

FIG. 1—Bag Holder and Carrier Open, Interior View

FIG. 2—Bag Holder and Carrier Open, Exterior View

FIG. 3—Bag Holder and Carrier Closed, Back View

FIG. 4—Bag Holder and Carrier Closed, Front View

FIG. 5—Bag Holder and Carrier on Shopping Cart, Front View

FIG. 6—Bag Holder and Carrier Attaching to Shopping Cart Handlebar, Side View

FIG. 7—Bag Holder and Carrier in the Process of Being Closed, Front View

### LIST OF REFERENCE NUMERALS

1. Middle Panel, the Handlebar Cover

2. Plastic Bag Dispenser

3. Elasticized Openings, to pull out or stuff in plastic bags

4. Open Pocket, for Paper and Cloth Bags

5. Second Pocket with Closure Mechanism, for Personal Items

6. Loop, on outer top seam of Open Pocket

7. Hook Fastener

8. Loop Fastener

9. Security Strap

10. Securing mechanism, such as buckle

11. Carrying Strap

### DETAILED DESCRIPTION

This embodiment is a bag holder and carrier for cloth, paper and plastic bags, performing the additional function of a handlebar cover for shopping carts. This bag carrier and holder is designed to hold and carry all types of bags that are typically used for bagging purchases while shopping. These bags are kept in an organized fashion in this bag carrier's specially designed compartments. The bag carrier is also a handlebar cover for any shopping cart handlebar, attaching snugly to any handlebar thickness, achieving the result of covering the handlebar grabbing surface. This embodiment has four main parts, each with its own function, which will be introduced through the drawings.

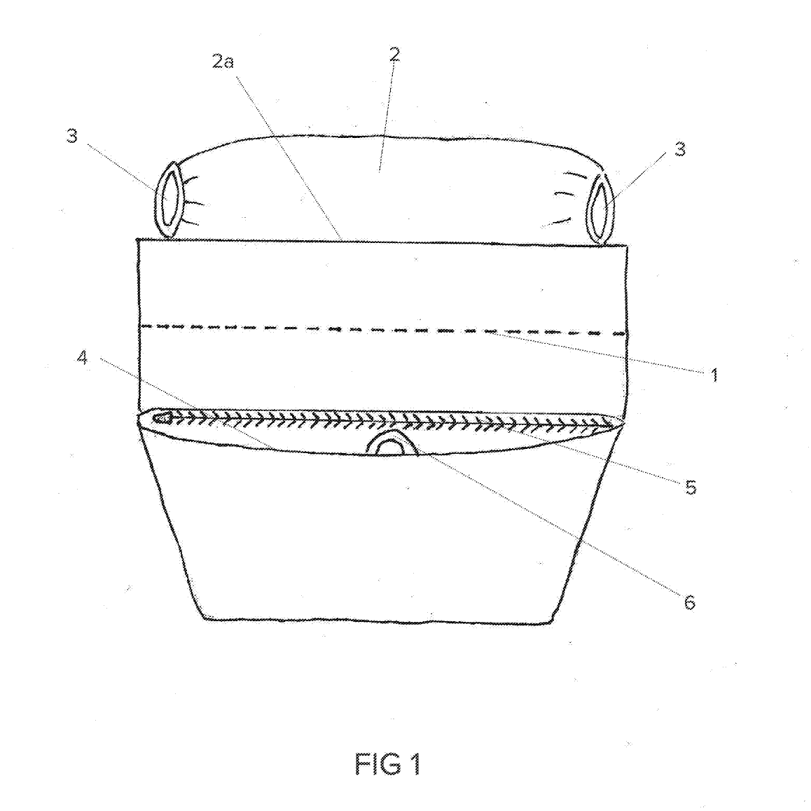

FIG. 1—Bag Holder and Carrier Lying Flat, Interior View

In this drawing you see all four main parts.

The Handlebar Cover

The first main part is the middle panel (1), also known as the handlebar cover, a rectangular section, made of cloth. It is designed to fold over any shopping cart handlebar, like a towel on a towel bar, and fit snugly around its grabbing surface. It covers the grabbing surface of the handlebar completely, providing a clean place to grab and push the shopping cart. The underside seam represented by the broken line, is where the handlebar would be. This middle panel can be made with one layer of cloth, which forms the interior or top side, sewn to two smaller pieces of cloth that are half the size of this layer, cut the long way. Soft padding may add a third layer, cut to the same size as the top layer, inserted between these two layers for hand comfort. This middle panel may be made for different-sized handlebars, so its size may vary. It may have any appropriate functional shape, including but not limited to a rectangular, trapezoidal or oval shape, and may be made of any appropriate fabric or combination of fabrics, including but not limited to cotton and/or nylon. This middle panel provides a germ barrier for the cart user, minimizing a shopper's possible contact with any cold or flu viruses on the handlebar, and preventing the shopper or the shopper's child from leaving their own germs, thus cutting down on bacterial or viral transmission in this fashion. It attaches to the handlebar securely, with the method of attachment in this embodiment being a hook/loop fastening system, with hook fasteners (7) sewn along the outer edges of one piece of this panel's underside, and loop fasteners (8) sewn along the outer edges of the opposite piece. It may attach to the cart in only these two places, or in any appropriate number of places, such as three places. Any appropriate functional and adjustable attachment mechanism may be used, including but not limited to hook and loop fasteners, magnetic clasps, snaps, or any attachment mechanism that has one part secured to another and is functional for the purpose of adjustable tightening to fit snugly around different-sized handlebars.

The Plastic Bag Dispenser

The second main part of this bag carrier is the plastic bag dispenser, (2) the embodiment in this drawing as a long cylindrical compartment, which is made by sewing together the two opposite longer sides of one rectangular layer of cloth, to form a cylinder, and then sewing elastic into the rounded edges on each end to make them stretchy and gathered. (3) This compartment is connected to the middle panel by sewing its long seam along one of the middle panel's longer sides. It will hang horizontally, parallel to the handlebar when put on the cart. When elasticized, the two openings (3) can be opened further by stretching the elastic open, and then letting the opening shrink back to its original size when released. This long cylindrical compartment (2) acts as a plastic bag dispenser for shopping purposes. For grocery or any kind of shopping, the plastic bag dispenser can be filled with numerous plastic bags or other squishy bags such as mesh or nylon bags. These squishy bags can be organized by type or size, storing and dispensing from different openings. The shopper is able to pull out an appropriate size or type of bag as needed, depending on its function. For example, produce bags can be stored and dispensed through the left elasticized opening, and larger plastic bags can be stored and dispensed through the right opening.

The plastic bag dispenser body may have other embodiments, taking any other shape that is functional for its purpose, including but not limited to cylindrical or trapezoidal, and may have one or more openings that may or may not be elasticized (stretchy). The openings of other embodiments may have the ability to be closed completely, and may not be elasticized.

The Large, Open Pocket for Paper Grocery Bags and Cloth Bags:

The third main part of this bag carrier is a large, open pocket (4) that is sewn into the opposite longer seam of the handlebar cover and runs the length of the handlebar. Its pocket opening is closest to the shopper when on the cart. This open pocket is designed to accommodate folded paper bags or folded cloth bags, so that they may be easily stored and transported for repeated use, and easily accessed when checking out at the register. In its simplest embodiment, it is formed by sewing two layers of cloth together around their 3 outer edges, and leaving the front top edge of the top layer open, so that an open pocket is formed. This large, open pocket may take any appropriate shape for its function, including but not limited to trapezoidal, rectangular, or square. This embodiment has a loop (6) made of webbing or any other appropriate material, sewn into its front top edge. This loop is one of the components used in the process of closing the bag carrier.

A Hidden, Secure Pocket as Temporary Storage for Personal Items: The fourth main part of this bag carrier seen in this drawing, is a second pocket (5) for personal items that is hidden behind the bags. This second pocket is formed by sewing a second layer of cloth of the same size and shape as the open pocket, on top of the open pocket's back internal layer. This embodiment uses a zipper as a means of closure of this second pocket, the zipper being sewn along both the top edge of this second layer and the back layer of the open pocket, forming a zippered second pocket. This second pocket can provide temporary storage of personal items such as wallet, keys or cell phone, while shopping. This second pocket may have a securing or closure mechanism such as a zipper, or any other appropriate closure mechanism, such as velcro or snaps, to keep personal items secure and hidden.

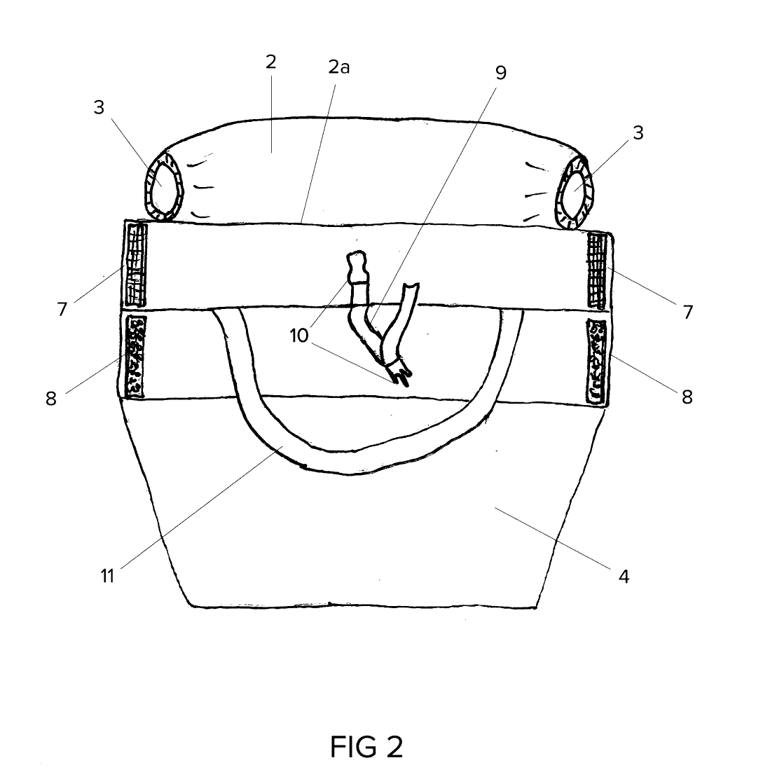

FIG. 2—Bag Holder and Carrier, Lying Flat, Exterior View

In this illustration you see the underside or exterior side of the bag carrier. The center seam is visible. In this embodiment, there is a security strap sewn into this center seam of the exterior underside of the middle panel, right in the center. This security strap provides a way to secure the bag carrier to the shopping cart handlebar, as well as to secure a purse handle onto the handlebar to prevent theft. In this embodiment, the security strap has a snap buckle (10). This security strap also provides a mechanism for closing the bag carrier when not in use, which I'll explain later. In this embodiment, the bag carrier has a carrying strap (11) sewn into this same center seam, which is useful for transporting the bag carrier when it is closed up. It can also be used to hang the bag carrier on the headrest of a car or somewhere in the home. This carrying strap may be longer or shorter, and may be a handle instead of a strap, depending upon whether it be for carrying on one's shoulder or by hand. In this figure you can also see the arrangement of the hook and loop fasteners along the outer underside edges of the middle panel. The hook fastener (7) is on one side of the center seam, and the loop fastener (8) is on the other. When put over the cart handlebar, the loop fastener is pressed against the hook fastener, fastening the outer edges together and making a snug fit around the bar.

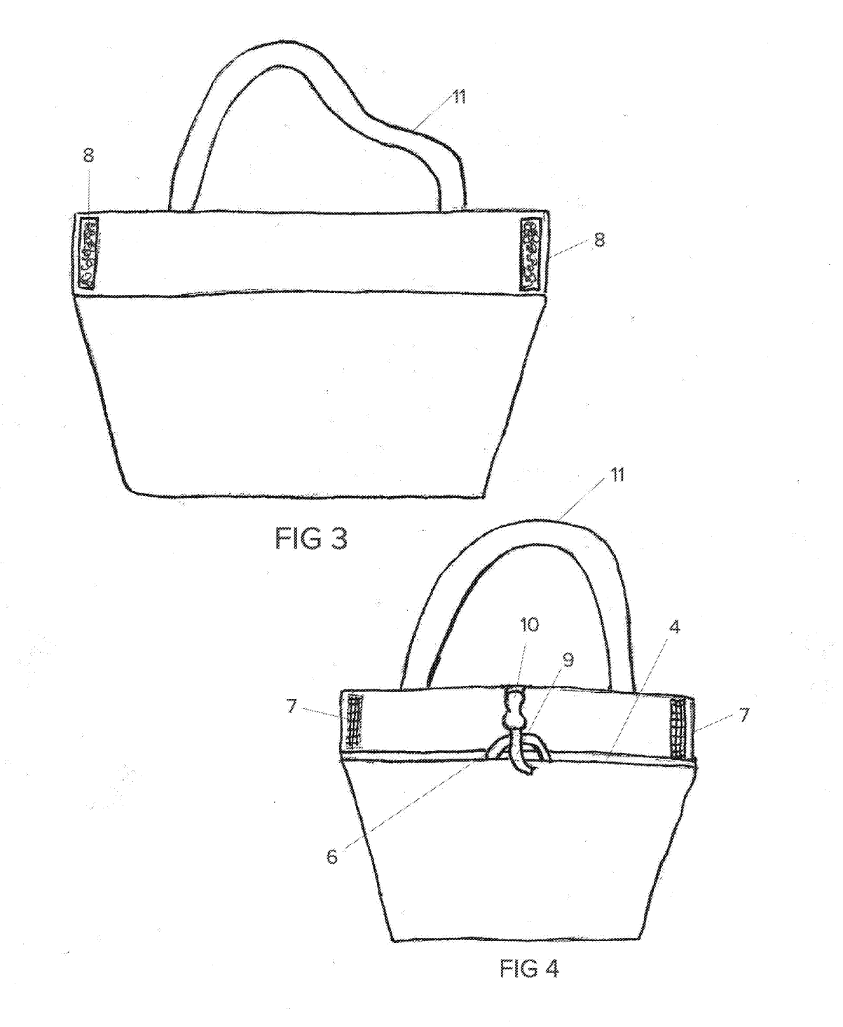

FIG. 3—Bag Holder and Carrier Closed, Back View

In the first drawing, (FIG. 3) one sees the back of the bag carrier when it is in its closed position. The loop fastener strips (8) are visible, as is the carrying strap (11).

FIG. 4—Bag Holder and Carrier Closed, Front View

In the second drawing, (FIG. 4) the carrying strap (11) and hook fasteners (7) are visible, as well as the front loop (6). Notice how the buckle (10) is also visible. The security strap is now on top of the bag carrier, and has been threaded through the front loop. The buckle has been snapped together to hold the bag carrier in its closed position. Now it is ready to be carried.

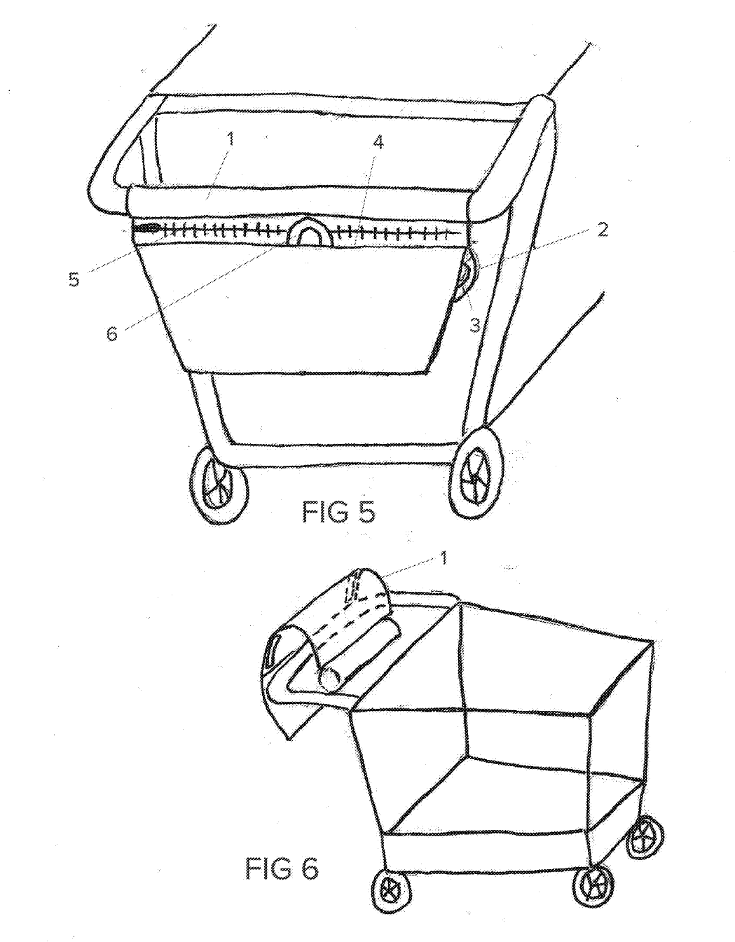

FIG. 5—Bag Holder and Carrier on Shopping Cart, Front View

In this drawing, the bag carrier has been placed on the shopping cart. The middle panel or handlebar cover (1) is draped over the handlebar, with the underside down. The hook (7) and loop (8) fasteners along each outer edge of this middle panel are pressed together and fastened up until the middle panel has a snug fit on the handlebar. The zipper of the hidden second pocket (5) is visible, running under the handlebar. The large, open pocket for paper and cloth bags (4) is waiting to be filled. One can see a glimpse of the one of the openings (3) of the plastic bag dispenser (2) on the right side, behind the open pocket. (4)

FIG. 6—Bag Holder and Carrier Attaching to Handlebar, Side View

Here you see the middle panel (3) going over the handlebar. Once it is set on the handlebar, the hook (7) and loop (8) fasteners will be pressed together. The large open pocket (4) will be closest to the shopper, and the plastic bag dispenser (2) will be behind the open pocket.

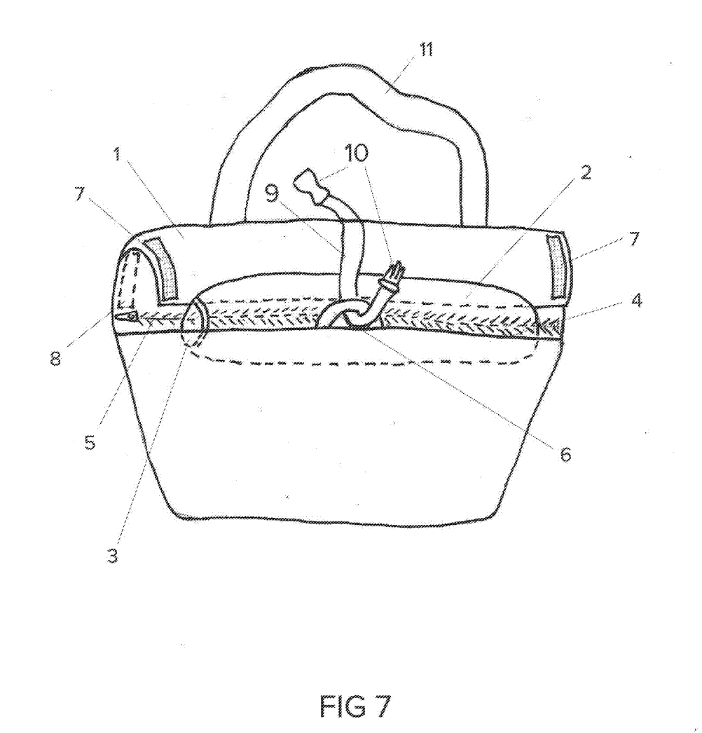

FIG. 7—Bag Holder and Carrier in the Process of Being Closed, Front View

In this figure, the bag carrier has been taken off the cart, and is in the process of being closed. To close the bag carrier, the plastic bag dispenser (2) is brought toward the open pocket (4) and stuffed inside. In this position, the carrying strap (11) and the security strap (9) are visible. The longer part of the security strap with male buckle part, is brought toward the loop (6) on the top edge of the open pocket, and is threaded through this loop and back to snap into the female part of the buckle. The buckle can be tightened by pulling the adjustable strap. In this closed position, the carrying strap (11) is on the top of the bag carrier for easy transport.

This middle panel provides a germ barrier for the cart user, minimizing a shopper's possible contact with any cold or flu viruses on the handlebar, and preventing the shopper or the shopper's child from leaving their own germs, thus cutting down on bacterial or viral transmission in this fashion. This middle panel goes over the handlebar like a towel over a towel bar and attaches to it securely, with one method of attachment being a hook/loop fastening system, with hook fasteners sewn along the outer edges of one piece of this panel's underside, and loop fasteners sewn along the outer edges of the opposite piece. It may attach to the cart in only these two places, or in any appropriate number of places, such as three places. Any appropriate functional and adjustable attachment mechanism may be used, including but not limited to hook and loop fasteners, magnetic clasps, snaps, or any attachment mechanism that has one part secured to another and is functional for the purpose of adjustable tightening to fit snugly around different-sized handlebars.

This embodiment of the shopping cart bag carrier with handlebar cover, security strap and carrying handle or strap, may be made of any appropriate fabric or combination of fabrics, including but not limited to nylon, cotton, mesh, polyester, or any other appropriately functional fabric. The hardware used may be any appropriate materials, including but not limited to plastic or metal center release or snap buckles. hook and loop fasteners, magnets, snaps, and webbing or fabric loops of any functional type and thickness.

Advantages

The embodiment of this bag carrier allows one to carry, hang, organize, access and store the articles inside, in this case all types of bags for shopping. It facilitates the re-use of a shopper's “set of bags”, and helps cut down on the number of single-use bags each shopper takes home. It helps a shopper organize their bags and keep them in one place in the home or in the car, making it easy to grab and go. This bag carrier reduces bag clutter in the home as well as in the environment, by having a place to store a set of bags that a shopper uses again and again until the bags wear out. A bag would be replaced only when one breaks or gets soiled. Since the bag carrier holds numerous bags, it's unlikely that a shopper would run out of bags while shopping. The end result of having a set of bags that one uses again and again is that it reduces the number of bags that have to be dealt with either by recycling or disposing. While shopping, the bag carrier is attached to the handlebar of a shopping cart, making the bags accessible for bagging produce or meats, and then at checkout. When on the cart, this bag carrier covers the gripping surface of the shopping cart handlebar, providing a protective germ barrier for a shopper and a shopper's loved ones while shopping. It gives a shopper the option of leaving one's purse in the car, as it has a secure zippered pocket to hold a wallet, phone or keys while shopping. This bag carrier can be used on strollers and some wheel chairs to carry bags and other personal articles while shopping at a street fair or spending the day at an amusement park.

### Other Embodiments

Other embodiments may involve different shapes and openings for each type of compartment and pocket, and the handlebar cover having a different shape, with the basic elements being the same. It would still be an article carrier that can fit snugly and adapt to any handlebar size or perhaps use the middle panel to attach and hang over another thin apparatus such as a child's chair at school, with compartments and pockets for different types of articles. The conversion from handlebar cover with pockets to a shoulder bag with a carrying strap, would stay the same. See FIGS. 8 and 9 for examples of other possible embodiments of this article carrier and holder, that could be used to carry, hang, organize, access, and store. They vary mostly by shape of the compartments and handlebar cover, and number of compartment openings. The applications of these embodiments could include a variety of situations as the compartments could be used to store and carry other things.

Another embodiment might be as a book bag to carry a child's school supplies. This “book bag” could be carried to school, opened up and hung on a child's chair, using the middle panel. (FIG. 11) Instead of the cylindrical compartment, an open flat pocket that can accommodate a zippered pillowcase could be attached for storage of a child's soft things, such as jacket and mittens, or a sweater. The child could rest against this pillow compartment on their chair back, and pull out the “pillow” to sit on it during story time. The books and notebooks could be stored in the large, open pocket on the other side, with pencils, erasers, markers and scissors stored in the zippered pocket. The carrying strap could be exchanged for backpack straps added to the back, running from the exterior center seam down to the bottom of the open pocket. (FIG. 10)

Another embodiment would be a bag on the handlebar of a bike for cyclists. They already have handlebar bags specifically for cyclists, but they are not easily taken off the handlebar when running in for a drink or snack, and are not meant to be carried around. This embodiment would be a smaller version of the article carrier and holder, that attaches to the handlebar easily, and fits it snugly, not covering or interfering with the gears or brakes. It would have a small handle or carrying strap sewn into the center seam on the underside, as well as a security strap for extra securing to the handlebar, and for closure of the bag. In this embodiment, the handlebar cover would be smaller by both dimensions. On both sides of the handlebar cover, the compartments sewn to each longer seam of the handlebar cover would be pockets of similar size and shape, one slightly smaller than the other. The smaller one would be a zippered pocket, where driver's license, money, cell phone and keys could be stored. The slightly larger one would be an open pocket, closest to the cyclist while riding, with the contents easily accessed while cycling, so a cyclist could easily grab a snack while riding, or reapply sunscreen. She might remove her vest or arm warmers and have a quick place to put them. A handkerchief for a runny nose, or a hat for later, could also be stored there. When removed from the handlebar, simply by detaching the loop and hook strips on each outer edge of the handlebar cover, the slightly smaller pocket would be stuffed into the other pocket, just as the cylindrical compartment was stuffed into the open pocket for closure, and the security strap would thread through the loop on the front edge of the larger pocket and secure them closed. The carrying strap would then be on the exterior upper side of the pack.

Another embodiment would be as an article carrier on the handlebar of a stroller when at a street fair or amusement park, or a long day at Disneyland. (FIG. 13) The open pocket could be used for drinks and snacks, as well as diapers, wipes and extra clothing. A parent's wallet, keys, and cell phone could go into the zippered pocket.

The cylindrical compartment could store shopping bags, plastic or cloth, as well as smaller plastic bags for dirty diapers, etc. When leaving the stroller for any reason, it's easy to pull it off the stroller and convert it into a shoulder bag. All the elements would basically be the same, with the article carrier being sized to fit the stroller.

An appropriately-sized embodiment could be used on the bar of a garden cart, as well as a small push cart for people who walk to the store.

And one last embodiment that I'll mention, would be as a saddle bag and purse on a walker for the elderly. Since it is so easy to remove from the handlebar, it could function as both. The zippered compartment could hold items like wallet and phone, and the open, drop-in pocket could hold other personal items such as a sweater, tissue, and hand lotion. The compartment on the other side could also be a zippered pocket like the example for the cyclist in FIGS. 12A and B. This saddlebag/purse could be easily removed from the walker bar and closed up when you want to have it close by, like in a restaurant or at the theater.

What is claimed is:

1. An article holder and carrier, in this embodiment a holder and carrier of all types of bags for shopping, that when opened can attach to a handlebar of a shopping cart or other push cart handlebar, covering its entire length, and fitting it snugly, achieving the result of making the contents of said article holder and carrier accessible to the user, and providing said user with a clean and comfortable grabbing surface on said handlebar, said article holder and carrier having a plurality of compartments and pockets of varying functionalities, that help organize and store articles, in this embodiment articles being paper, plastic and cloth bags, with said articles being accessible when in an opened position hanging from said handlebar, said article holder and carrier, when removed from said handlebar, closes into a carrying bag with carrying strap or handle, achieving the result of easy transport and storage, comprising:
a. a middle panel, in this embodiment having a rectangular shape, long enough to cover the length of said handlebar, and sufficiently wide to envelope the handlebar thickness and fasten securely under said handlebar, said middle panel which may or may not be padded for a user's grabbing comfort, with fasteners of a type that can be adjusted for tightness, in this embodiment hook and loop fasteners sewn along the outer side edges of the underside of said middle section, said middle panel taking any functional shape, including but not limited to rectangular, oval or trapezoidal, whereby performing the function of attaching snugly to said handlebar and covering it completely, providing a protective barrier that impedes the transmission of cold and flu germs from one user to the next as well as attaching said article holder and carrier to said handlebar, said middle panel having an adjustable security strap with an appropriate securing mechanism, such as a snap-together buckle or hook and loop fasteners, that is sewn into the center seam of the exterior or underside of said middle panel, performing the functions of securing said article holder and carrier to said handlebar as well as securing said holder and carrier into its closed position when removed from the cart and closed up for carrying, said middle panel having a carrying strap or handle sewn into said center seam of the exterior or underside of said middle panel, said carrying strap or handle being of any width and length appropriate to perform the function of carrying said article holder and carrier on a shoulder or by hand, said carrying strap or handle is revealed on top of said article carrier when said carrier is in said closed position, and achieves the result of being able to carry said article holder and carrier on one's shoulder or in one's hand for easy transport, or to hang on a car headrest or on a hook at home.
b. a compartment of any appropriate shape and size suitable to the size of said article holder and carrier and said shopping cart, with a plurality of openings appropriate for said purpose of storing plastic bags or other articles, in this embodiment an elongated cylindrical compartment with two elasticized openings, one on each end, joined by sewing to a longer side of said middle panel so that said cylindrical compartment runs parallel to said handlebar when said article carrier is on the cart, whereby in this embodiment, performing the function of holding, organizing and dispensing any type of plastic or cloth squish-able bags, such as mesh or nylon bags, by means of stuffing said bags in or pulling them out of said elasticized openings of said compartment, said compartment being made of nylon or cotton, or any appropriate fabric for said function.
c. a larger open pocket, joined by sewing to the opposite longer side of said middle panel, that in this embodiment is made large enough to accommodate multiple folded paper and cloth bags, whereby performing the function of holding and dispensing said paper and cloth bags while shopping, said open pocket having a loop made of webbing or other suitable material, sewn into its top outer edge in the center, with an opening large enough to thread a strap of webbing or other material through said opening, whereby said loop is part of the process of holding said article holder and carrier in its closed position.
d. a secure, hidden pocket made by sewing a layer of fabric of similar size and shape as said open pocket, into the back panel of said open pocket, with any suitable closure mechanism, in this embodiment a zipper, whereby said hidden pocket achieves the result of providing hidden storage behind folded bags, to keep a shopper's personal items such as phone, wallet or keys, secure while shopping.
e. said article holder and carrier being of any size appropriate for different-sized shopping carts or other embodiments, and taking any form or shape appropriate to varying embodiment functions, said article holder and carrier being made with any combination of fabrics such as cotton and nylon, that are appropriate for comfort, washability, and purpose, in this embodiment said purpose of holding, carrying, and organizing paper, plastic and cloth bags.

2. Said article holder and carrier of claim 1, using a method of covering and attaching, used to attach said bag holder and carrier to said shopping cart handlebar, which achieves the result of easy adjustment and fitting snugly to different handlebar thicknesses while being attached, whereby said middle panel of said article holder and carrier wraps over said handlebar like a towel over a towel bar, covering the length of said handlebar, and attaching together the underside outer edges of said middle panel by means of hook and loop fasteners, or any other appropriate fastening system that holds these edges together, said underside outer edges being pressed together and fastened up toward said handlebar to the appropriate tightness, said middle panel taking any shape appropriate to accomplish said attachment method, including but not limited to rectangular, oval or trapezoidal, said method of covering and attaching to said handlebar achieving the added result of providing a clean and comfortable grabbing surface for the shopper.

3. Said article holder and carrier of claim 1 using a method of closure of this embodiment of said bag holder and carrier when removed from any shopping cart handlebar or other type handlebar, in this embodiment whereby said cylindrical compartment, or plastic bag dispenser, is inserted into said open pocket, and said security strap is pulled toward the top edge of the open pocket where said loop is, and is threaded through the opening of said loop, in this embodiment achieving the result of transforming said bag holder and carrier from a handlebar cover and shopping cart bag organizer, into a closed bag carrier when said security strap is secured. In this closed position, this embodiment performs the function of said closed carrier full of all types of bags, that is easily carried from car to cart, or hung on the headrest of a car or somewhere at home, using said carrying strap or handle.
